(19) United States
(12) Patent Application Publication
(10) Pub. No.: US 2011/0228808 A1
(43) Pub. Date: Sep. 22, 2011

(54) SYSTEM AND METHOD FOR COLLECTING AND ANALYZING THE MEASUREMENTS AND OBSERVATIONS REQUIRED DURING FLAMMABILITY TESTING

(75) Inventors: Frank Ayotte, Union, KY (US); Wendy Sterling, Independence, KY (US); Elizabeth Kelly, Florence, KY (US)

(73) Assignee: TICONA LLC, Florence, KY (US)

(21) Appl. No.: 12/727,471

(22) Filed: Mar. 19, 2010

(51) Int. Cl. G01N 25/00

(52) U.S. Cl. 374/8

(57) ABSTRACT

A system and method are disclosed for collecting and analyzing the measurements and observations required during flammability testing of materials. The system may include one or more input devices for electronically providing one or more timing signals related to a timing sequence of a specified flammability test and one or more attribute signals related to selected attributes of a test specimen. Additionally, a timing device may be coupled to the one or more input devices. The timing device may be configured to perform one or more time interval measurements based on the one or more timing signals. Further, a computing device may be coupled to the timing device. The computing device may be configured to analyze the one or more time interval measurements and the one or more attribute signals to determine a flammability classification for the test specimen in accordance with the specified flammability test.

### FIELD OF THE INVENTION

The present subject matter relates generally to flammability tests conducted on test materials and particularly to a system and method for collecting and analyzing the measurements and observations required during flammability testing in order to determine the flammability classification of a test material.

### BACKGROUND OF THE INVENTION

Materials used in many consumer products are often evaluated under standardized testing procedures to rate certain characteristics regarding the material. For example, plastic materials are often tested to determine their flammability or burning characteristics due to the fact that, when exposed to sufficient heat, such materials are capable of igniting in the presence of oxygen. Thus, it may be of particular importance to determine a plastic's flammability characteristics/classification as a preliminary step in deciding whether the plastic would be acceptable for use in a component of a high temperature consumer product, such as an appliance or an electrical device.

There are numerous plastic flammability standards known in the art. For example, a well-known standard released by UNDERWRITERS LABORATORIES, INC. (Northbrook, Ill.), UL94, classifies plastics based on small-scale flame tests designed to measure the propensity of a plastic material to extinguish flames once the material becomes ignited. Standardized test procedures are used to establish such classifications. For example, for the classifications V-0, V-1 or V-2, plastic materials are subjected to a vertical burn test. Generally, this test requires an operator to place a test specimen over the controlled flame of a burner. The specimen is exposed to the flame for a period of ten seconds and then observed to determine the length of time required for the afterflame to extinguish. The specimen is then re-exposed to the flame for another ten second period and again observed to determine time required for the afterflame to extinguish. After such time, the specimen is further observed to determine the amount of time the specimen afterglows. The operator must also observe several attributes relating to the specimen. For example, the operator must visually note whether the specimen burned completely up to the specimen holder and whether the specimen dripped so as to ignite a cotton indicator placed under the specimen.

As should be readily understood from the description above, the UL94 testing procedure requires an operator to make various observations and time measurements while simultaneously moving a flame towards and/or away from the test specimen. As such, it should be appreciated that the test can be very difficult to accurately conduct, especially with regard to the taking and recording of time measurements. In particular, for a single test under the UL94 testing procedure, an operator must take and record three separate time measurements, all while observing the status of the test specimen and/or moving the flame with respect to the specimen.

Accordingly, there is a need for a system that provides for the efficient, accurate and repeatable collection and analysis of the measurements and observations require during flammability testing.

### BRIEF DESCRIPTION OF THE INVENTION

Aspects and advantages of the present subject matter will be set forth in part in the following description, or may be obvious from the description, or may be learned through the practice of the present subject matter.

Generally, the present subject matter is related to a system and method for collecting and analyzing the measurements and observations required during flammability testing in order to determine the flammability classification of a test material. In particular, the present subject matter discloses a system and method that greatly increases the efficiency and repeatability of collecting and analyzing such measurements and observations.

In one embodiment of the present subject matter, the system includes one or more input devices for electronically providing one or more timing signals related to a timing sequence of a specified flammability test and one or more attribute signals related to selected attributes of a test specimen; a timing device coupled to the one or more input devices, the timing device being configured to perform one or more time interval measurements based on the one or more timing signals; and a computing device coupled to the timing device, the computing device being configured to analyze the one or more time interval measurements and the one or more attribute signals to determine a flammability classification for the test specimen in accordance with the specified flammability test.

In this aspect of the present subject matter, the system further comprises a testing unit including a burner element and a specimen holder, the burner element being configured to produce a controlled flame and the specimen holder being configured to hold the test specimen adjacent to the burner element to permit exposure of the test specimen to the controlled flame.

Also in this aspect of the present subject matter, the one or more input devices comprise a timer button and one or more attribute switches.

Further in this aspect of the present subject matter, the one or more input devices may be further configured to electronically provide a test selection signal that configures the timing device to perform the one or more time interval measurements based on a timing sequence of a first specified flammability test or a second specified flammability test.

In this aspect of the present subject matter, the selected attributes of the test specimen may comprise whether the test specimen burned up to a specified location and whether the test specimen dripped and ignited a cotton indicator.

Also in this aspect of the present subject matter, the selected attributes of the test specimen may comprise an unburned length of the test specimen.

Further in this aspect of the present subject matter, the system further comprises an audio output device for producing an audible alarm, the audible alarm being produced to indicate that a flame exposure period of the timing sequence has run.

In this aspect of the present subject matter, the timing device may comprise a hard-wired circuit that configures the timing device to perform the one or more time interval measurements.

Also in this aspect of the present subject matter, the timing device may comprise computer-readable medium storing instructions that configure the timing device to perform the one or more time interval measurements.

In another embodiment of the present subject matter, the system includes one or more input devices for electronically providing one or more timing signals related to a timing sequence of a specified flammability test and one or more attribute signals related to selected attributes of a test specimen; and a computing device coupled to the one or more input devices, the computing device being configured to perform one or more time interval measurements based on the one or more timing signals and analyze the one or more time interval measurements and the one or more attribute signals to determine a flammability classification for the test specimen in accordance with the specified flammability test.

In this aspect of the present subject matter, the system further comprises a testing unit including a burner element and a specimen holder, the burner element being configured to produce a controlled flame and the specimen holder being configured to hold the test specimen adjacent to the burner element to permit exposure of the test specimen to the controlled flame.

Also in this aspect of the present subject matter, the one or more input devices may comprise a timer button.

Further in this aspect of the present subject matter, the one or more input devices may comprise a mouse or a keyboard.

In this aspect of the present subject matter, the one or more input devices may be further configured to electronically provide a test selection signal that configures the computing device to perform the one or more time interval measurements based on a timing sequence of a first specified flammability test or a second specified flammability test.

Also in this aspect of the present subject matter, the selected attributes of the test specimen may comprise whether the test specimen burned up to a specified location and whether the test specimen dripped and ignited a cotton indicator.

Further in this aspect of the present subject matter, the selected attributes of the test specimen may comprise an unburned length of the test specimen.

In this aspect of the present subject matter, the system further comprises an audio output device for producing an audible alarm, the audible alarm being produced to indicate that a flame exposure period of the timing sequence has run.

Also in this aspect of the present subject matter, the computing device comprises a computer-readable medium storing instructions that configure the computing device to perform the one or more time interval measurements and analyze the one or more time interval measurements and the one or more attribute signals to determine a flammability classification for the test specimen in accordance with the specified flammability test.

In a further embodiment of the present subject matter, the method may include electronically receiving a plurality of timing related to a timing sequence of a specified flammability test; electronically receiving one or more attribute signals related to selected attributes of a test specimen; automatically performing time interval measurements based on the timing signals; and analyzing the time interval measurements and the one or more attribute signals to determine a flammability classification for the test specimen in accordance with the specified flammability test.

In this aspect of the present subject matter, the time interval measurements may be performed by a timing device or a computing device.

These and other features, aspects and advantages of the present subject matter will become better understood with reference to the following description and appended claims. The accompanying drawings, which are incorporated in and constitute a part of this specification, illustrate embodiments of the present subject matter and, together with the description, serve to explain the principles of the present subject matter.

### BRIEF DESCRIPTION OF THE DRAWING

A full and enabling disclosure of the present subject matter, including the best mode thereof, directed to one of ordinary skill in the art, is set forth in the specification, which makes reference to the appended figures, in which:

FIG. 1 illustrates a front, perspective view of an embodiment of a testing unit in accordance with an aspect of the present subject matter;

FIG. 2 illustrates a front, interior view of an embodiment of a testing unit in accordance with an aspect of the present subject matter;

FIG. 3 illustrates a flow diagram of the general testing procedure/timing sequence for UL94 flammability testing;

FIG. 4 illustrates a flow diagram of the general testing procedure/timing sequence for FMVSS302 flammability testing;

FIG. 5 illustrates a schematic depiction of an embodiment of a system for collecting and analyzing the measurements and observations required during flammability testing in order to determine the flammability classification of a test material in accordance with an aspect of present subject matter;

FIG. 6 illustrates a front view of an embodiment of a timing device in accordance with an aspect of the present subject matter, particularly illustrating the cover panel of the timing device.

FIG. 7 illustrates an flow diagram of an embodiment of the steps executed to automate the timing sequence of a UL94 test in accordance with an aspect of the present subject matter;

FIG. 8 illustrates a screenshot view from an output in accordance with an aspect of the present subject matter; and

FIG. 9 illustrates a schematic depiction of a further embodiment of a system for collecting and analyzing the measurements and observations required during flammability testing in order to determine the flammability classification of a test material in accordance with an aspect of the present subject matter.

### DETAILED DESCRIPTION OF THE INVENTION

Reference now will be made in detail to embodiments of the present subject matter, one or more examples of which are illustrated in the drawings. Each example is provided by way of explanation of the present subject matter, not by way of limitation. In fact, it will be apparent to those skilled in the art that various modifications and variations can be made in the present subject matter without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the appended claims and their equivalents.

The present subject matter relates generally to conducting flammability testing on materials. In particular, the present subject matter relates to a system and method for collecting and analyzing the measurements and observations required during flammability testing in order to determine the flammability classification of a particular test material, such as a plastic material. The system and method will be generally described herein with reference to flammability testing of plastics conducted in accordance with the UL94 flammability standard released by UNDERWRITERS LABORATORIES, INC. (Northbrook, Ill.) and the FMVSS302 standard of the Federal Motor Vehicle Safety Standards released by the National Highway Traffic Safety Administration. Reference herein to the FMVSS302 standard should also be understood to refer to the SAE J369 standard released by SAE INTERNATIONAL (Warrendale, Pa.), which is a technical equivalent of the FMVSS302 standard.

It should be appreciated, however, that the system and method disclosed herein need not be limited to flammability testing of plastic materials. For example, the system and method of the present subject matter may be used to improve the collecting and analyzing of information required for the flammability testing of any type of material. For example, test materials may include any type polymeric material, such as thermoplastic materials, thermoset materials, compounded plastics, and the like, or generally any material that may be subjected to flammability testing, such as certain types of metals. Moreover, the present system and method may be utilized with flammability testing conducted on fabrics, including woven, non-woven and knitted fabrics, component parts, such as molded and cast parts, or any other articles.

It should also be appreciated that application of the system and method of the present subject matter need not be limited to flammability testing. In general, the system and method of the present subject matter may be used with various testing procedures wherein time measurements are required to be collected and analyzed. Thus, the system of the present subject matter may be utilized with any testing that requires timing input signals to be provided by a user in response to a specified timing sequence associated with the testing. For example, one of ordinary skill in the art should appreciate that the system and method of the present subject mater may be beneficially applied to various standardized consumer product testing procedures used in industry to rate and/or classify products and/or materials.

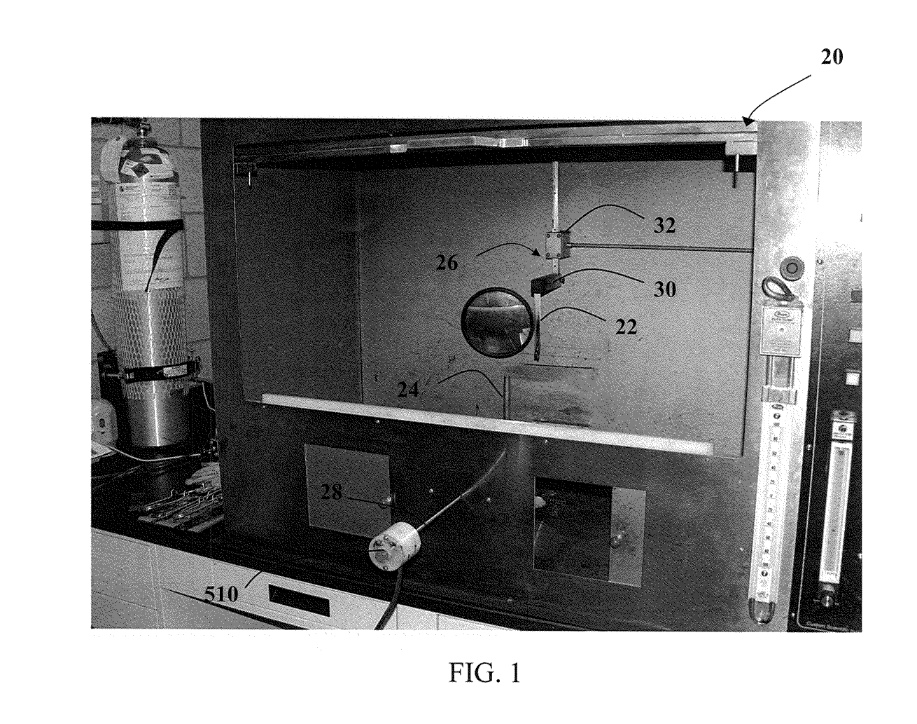

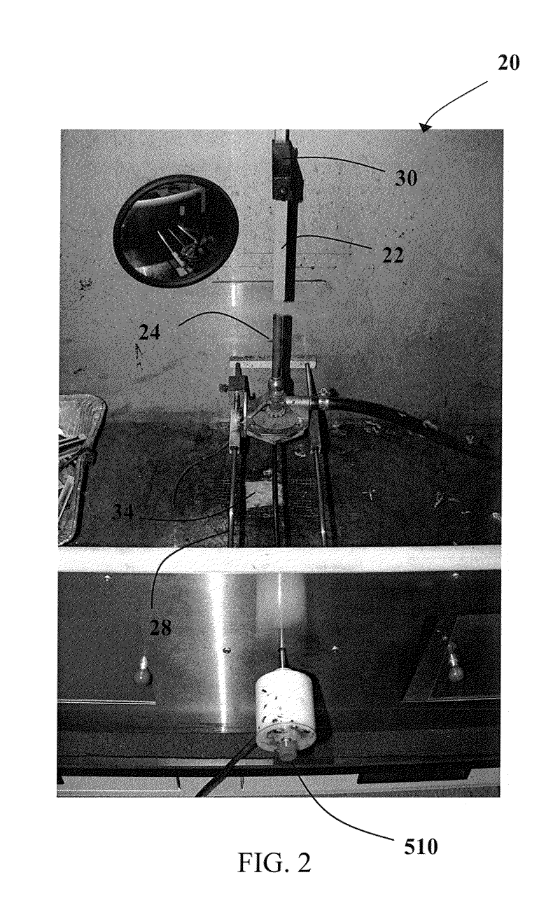

Referring to the drawings, FIGS. 1 and 2 illustrate an embodiment of a testing unit that may be used to conduct flammability testing in accordance with the system and related methods of the present subject matter. Specifically, FIG. 1 illustrates a front perspective view of the testing unit 20 and FIG. 2 illustrates a front interior view of the testing unit 20. The testing unit 20 may be generally configured to expose a test specimen 22 to a controlled flame. Thus, the testing unit may include a burner element 24 and a specimen holder 26. The burner element 24 may be configured to produce a controlled flame. Thus, it should be appreciated that the burner element 24 may comprise any gas burner generally known in the art which has the capability of adjusting flame characteristics of a flame. For example, in one embodiment, the burner element 24 may comprise a burner, such as Bunsen burner, with an adjustable air inlet and a device for adjusting the flow rate of the gas supplied to the burner. As such, the burner element 24 may be capable of producing a flame of a certain temperature and height, as required by many standardized testing procedures. Additionally, the position of the burner element 24 within the testing unit 20 may be adjustable to allow the burner element 24 to be moved in the direction of or away from the specimen 22 during testing. For example, as shown in FIG. 2, the burner element 24 may be connected to a slide mechanism 28 that permits an operator to adjust the position of the burner element 24 with respect to the test specimen 22.

The specimen holder 26 may generally comprise any mechanism capable of holding the test specimen 22 in a position relative to the flame of the burner element 24. Thus, in one embodiment, the specimen holder 26 may simply comprise a clamp connected a stand to allow the test specimen to be maintained above or adjacent to the flame. In an exemplary embodiment, the specimen holder 26 may be configured to adjust the position of the test specimen 22 with respect to the burner element 24. For example, as shown in FIG. 1, the specimen holder 24 may comprise a clamp 30 configured to hold the specimen 22 over the controlled flame and a height adjustment mechanism 32 configured to permit the position of the specimen 22 to be adjusted vertically during testing. For example, it may be necessary to move the specimen 22 downwardly as the specimen 22 melts during flammability testing. It should be appreciated that height adjustment mechanism 32 may generally comprise any suitable mechanism capable of altering or adjusting the position of the test specimen 22. For instance, in one embodiment, the height adjustment mechanism 32 may include a rack and pinion type arrangement for vertically positioning the test specimen 22. In such an embodiment, a knob or other turning device (not illustrated) may be coupled to the pinion gear to permit the operator to easily adjust the specimen's position during testing.

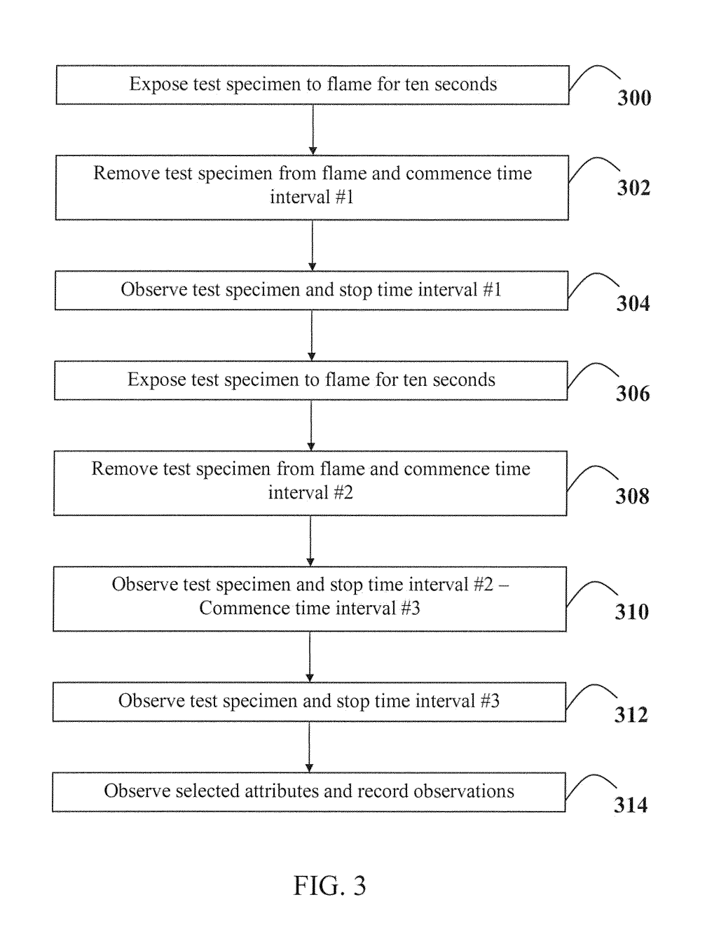

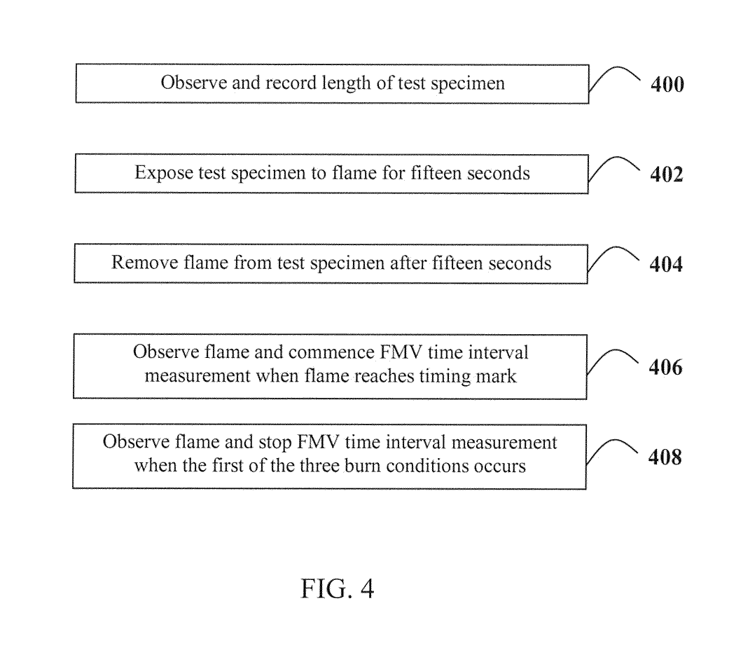

As indicated above, it should be appreciated that, generally, the subject matter disclosed herein may be utilized to conduct any type of flammability testing. However, for purposes of illustration, the UL94 and FMVSS302 testing procedures will be described below with reference to FIGS. 3 and 4. For example, FIG. 3 illustrates a flow diagram of the testing procedure/timing sequence for UL94 testing. Of course, it should be appreciated that, initially, a test specimen 22 having standard dimensions must be vertically loaded in the specimen holder 26 and the flame of the burner element 24 must be adjusted, if necessary, to a predetermined height.

After this initial set-up procedure, in step 300, the test specimen 22 is exposed to the controlled flame for a period often seconds. Thus, utilizing the testing unit 20 described above, an operator may push the burner element 24 to a position underneath the specimen 22 and adjust the height of the specimen 22, if necessary, to properly expose the specimen 22 to the flame. After the ten second period has elapsed, step 302 requires that the specimen 22 be removed from the flame. For example, the test operator may pull the burner element 24 away from the test specimen 22. Additionally, step 302 requires, simultaneous with the removal of the specimen 22 from the flame, the commencement of a first after flame time measurement (hereinafter “time interval #1”). Time interval #1 constitutes a measurement of the amount of time it takes for the after flame of the test specimen 22 to extinguish after removal of specimen 22 from the controlled flame of the burner element 24. This typically requires an operator to visually observe the test specimen 22 in order to determine the exact moment when the after flame extinguishes such that the time measurement for time interval #1 may be stopped, as shown by step 304.

In step 306, the test specimen 22 is re-exposed to the controlled flame for another period of ten seconds. After such exposure period, step 308 requires that the specimen 22 be removed from the flame and that a second afterflame time measurement (hereinafter “time interval #2”) be commenced simultaneously therewith. Time interval #2 constitutes a measurement of the amount of time it takes for the afterflame of the test specimen 22 to extinguish after removal of specimen 22 from the controlled flame of the burner element 24. Thus, step 310, similar to step 304, requires an operator to visually observe the test specimen 22 in order to determine the exact moment when the afterflame extinguishes such that the time measurement for time interval #2 may be stopped. Moreover, step 310 requires the commencement of an afterglow time measurement (“time interval #3”), which measures the amount of time it takes for the test specimen 22 to cease glowing or burning subsequent to the afterflame extinguishing. Thus, in step 312, the test specimen 22 must be observed to monitor the afterburn to enable time interval #3 to be measured.

The UL94 testing procedure also requires the recordation of selected attributes related to the testing specimen 22, namely whether the specimen 22 burned all the way up to the specimen holder 26 and whether the specimen 22 dripped and ignited a cotton indicator 34 (FIG. 2) disposed under the specimen 22. Thus, step 314 requires that such selected attributes be observed and recorded by the operator. It should be appreciated that the above identified steps, steps 300-314, generally outline the testing procedure, as well as the timing sequence for all UL94 testing. Specifically, the timing sequence, in continuous order, includes: a ten second exposure, time interval #1, a ten second exposure, time interval #2 and time interval #3. Of course, one of ordinary skill in the art should appreciate that the testing procedure must be repeated for multiple specimens, for example a total number of five test specimens.

FIG. 4 generally illustrates the testing procedure/timing sequence for FMVSS302 testing. Initially, a test specimen 22 is horizontally loaded in the specimen holder 26. Similar to the UL94 standard, the FMVSS302 standard requires that a selected attribute of the test specimen be recorded (i.e. the initial length of the specimen 22). Thus, in step 400, the initial length of the test specimen 22 should be observed and recorded. However, it should be appreciated that this may be unnecessary when a test specimen of standard dimensions is being used with the testing. In step 402, the test specimen 22 is exposed to the flame of the burner element 24 for a period of fifteen seconds. In step 404, the flame is removed from the test specimen 22 after the required exposure period. After removal of the burner element flame, the flame still burning on the specimen 22 is observed as is it spreads across the specimen 22 and until it reaches a particular timing mark. The timing mark, for example, may be located 38 mm from the free end of the specimen 22 (i.e. the end of the specimen 22 not clamped with the specimen holder 26). Once the flame reaches this mark, step 406 requires a time measurement (hereinafter “FMV time interval”) to be commenced, which generally measures the time it takes for the first of the following three burn conditions to occur: (1) a burn distance of 254 mm on the specimen 22 has been reached; (2) the flame on the specimen 22 extinguishes; or (3) the total length of the specimen 22 has been burned. Thus, the flame burning on the specimen 22 is observed until the first of the three burn conditions occurs, at which time the FMV time interval measurement is stopped, as shown in step 408. It should be readily appreciated that the above identified steps, steps 400-408, generally outline the testing procedure, as well as the timing sequence for FMVSS302 testing. Specifically, the timing sequence includes a fifteen second exposure period and a FMV time interval.

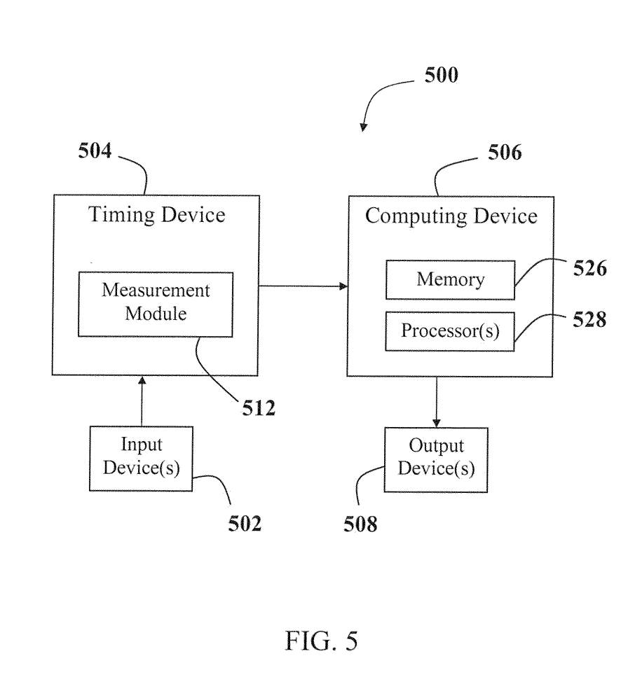

In accordance with an aspect of the present subject matter, FIG. 5 illustrates a schematic depiction of an embodiment of a system 500 for collecting and analyzing the measurements and observations required during flammability testing in order to determine the flammability classification of a test material. Generally, the system 500 may include one or more input devices 502 for electronically providing input signals. A timing device 504 may be coupled to the input device(s) 502 and may be configured to perform one or more required measurements based on a timing sequence of a specified flammability test, such as the timing sequences generally described above. Additionally, a computing device 506 may be coupled to the timing device 504 and may be configured to analyze time measurements and/or signals received from the timing device 504 to determine the flammability classification of the test specimen 22 in accordance with the specified flammability test. Further, the system may also include one or more output devices 508, such as a monitor, printer or other device, for visually depicting any available output data, such as time measurements, flammability classifications, and the like.

As indicated above, the input device(s) 502 of the present subject matter may be configured to electronically provide input signals. Generally, the nature and/or number of input signal's provided by the input device(S) 502 may vary depending on the particular flammability test being conducted. For example, the input device(s) 502 may be configured to provide timing signals related to a timing sequence of a specified flammability test, such as the timing sequences for the UL94 or FMVSS302 testing. Additionally, in one embodiment, the input device(s) 502 may provide attribute signals related to selected attributes of the test specimen 22. For instance, the input devices 502 may provide attribute signals for the selected attributes required for UL94 or FMVSS302 testing. Moreover, the input device(s) 502 may also be configured to provide a test selection signal that indicates to the timing device 504 which flammability test is being conducted. For example, the test selection signal may indicate that a UL94 or FMVSS302 test is going to be performed. It should be appreciated that the input device(s) 502 may generally comprise any device capable of providing an input signal. For example, the input device(s) 502 may comprise one or more peripheral devices configured to serve as an operator interface with the timing device 504. Thus, it should be appreciated that the input device 502 may comprise a button, a switch, a keyboard, a touch-screen monitor, a microphone, a mouse or any other suitable device.

At least one of the input device(s) 502 may comprise a timer button 510 (FIGS. 1 and 2) configured to be manually pushed/pressed by an operator in order to provide timing signals to the timing device 504. As indicated above, the timing signals may be related to a timing sequence of the flammability test being conducted. As such, in one embodiment, an operator may push/press the timer button 510 during the course of testing to indicate that a time interval measurement, such as time interval #1, time interval #2 or time interval #3, should be commenced/initiated and/or stopped.

It should be appreciated that the timer button 510 may generally be disposed at any location that permits an operator to push/press the button 510 during testing. For example, as shown in FIGS. 1 and 2, the timer button 510 may be disposed at the end of the slide mechanism 28 to permit an operator to quickly and accurately press/push the button 510 as the burner element 24 is being moved away from and/or towards the test specimen 22. In other words, the operator may be able to press/push the button while simultaneously positioning the burner element 24, which allows for accurate and repeatable test results. Additionally, it should be appreciated that various other input devices 502 may be utilized to provide timing signals. For instance, in an alternative embodiment, a keyboard or a mouse may be utilized to provide timing signals to the timing device 504.

Generally, the timing device 504 of the present subject matter may be coupled to the input device(s) 502 and may be configured to receive input signals from such device(s) 502. Additionally, the timing device 504 may be configured to perform one or more time interval measurements based on the one or more timing signals received by the timer button 510, or other suitable input device 502. For instance, the timing device 504 may be configured to analyze the timing signals based on a specified timing sequence to perform time interval measurements. In other words, the timing device 504 may be capable of automating the timing sequence required for a flammability test in order to perform any necessary time interval measurements. To facilitate such automation, the timing device 504 may comprise a measurement module 512 configured to implement a specified timing sequence. For example, in one embodiment, the measurement module 512 may include hard-wired logic or other circuitry, including, but not limited to application specific circuits, that permit the timing device to implement or execute the timing sequence of a flammability test and, thus, perform any needed time interval measurements. In an alternative embodiment, the measurement module 512 may include one or more processors and one or more memory elements. In such an embodiment, the processor(s) may be configured to execute computer-readable instructions stored in the memory element(s) to enable the timing device to perform time interval measurements. It should also be appreciated that, in further embodiments, the measurement module 512 may include hard-wired logic as well as processors and memory elements.

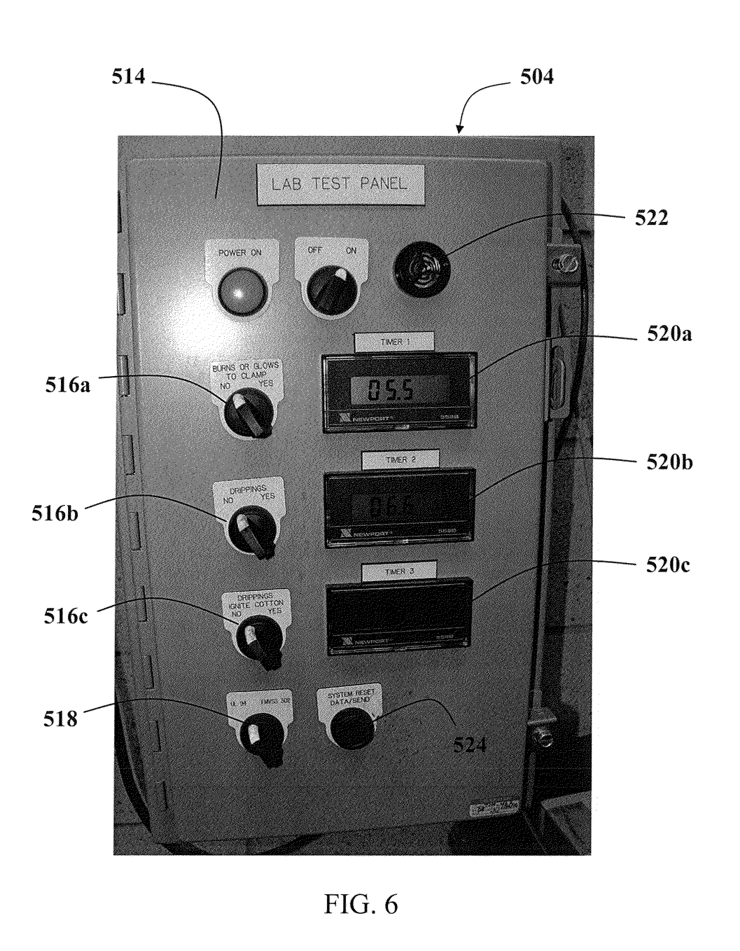

In addition to being coupled to the timer button 510, the timing device 504 may also be coupled to numerous, other input devices 502. For example, FIG. 6 illustrates an embodiment of a control panel 514 for the timing device 504 which serves as an interface between the timing device 504 and the operator before, during or after the testing. For example, the control panel 514 may include a plurality of input devices 502, such as switches or buttons, that may be manipulated by the operator. In one embodiment, the control panel 514 may include a plurality of attribute switches 516a,516b,516c for electronically providing one or more attribute signals related to selected attributes of a test specimen 22. For example, the attribute switches 516a,516b,516c may be used by the operator to record observations made during testing. Thus, as shown in FIG. 6, attribute switches 516a,516c may provide attribute signals relating to the selected attributes required for UL94 testing. However, the attribute switches 516a,516b,516c need not be limited to inputting attribute signals related to attributes required for testing. For instance, further attribute switches may also be included on the control panel 514, such as attribute switch 516b, which may be used to identify additional attributes of the test specimen 22 (e.g. whether the test specimen 22 dripped during testing). It should be appreciated that, in one embodiment, the attribute switches 516a,516b,516c may generally input a signal to the timing device 504 indicating a true or false condition. For example, the attribute switches 516a,516b,516c may indicate a “yes” answer by a 1 and a “no” answer by a 0. It should also be appreciated that the switches 516a,516b,516c may be normally set to “no” and, thus, may only need to be manipulated in the event of a “yes” answer.

In one embodiment, the control panel 514 may also include an attribute switch or other suitable input device (not illustrated) for electronically inputting an attribute signal relating to the initial, unburned length of the test specimen 22. However, it may often be the case, such as with FMVSS302 testing, that the initial length of the specimen 22 to be tested must conform to the standardized specimen dimensions for a particular flammability test. In such case, the initial length of the specimen 22 may be pre-programmed into and/or stored within the timing device 504 or computing device 506 and, therefore, may be automatically provided as an attribute signal within the system 500 of the present subject matter.

Referring still to FIG. 6, the control panel 514 may further include a test selection switch 518 for electronically providing a test selection signal that configures the timing device 504 to perform one or more time interval measurements based on the timing sequence of a particular flammability. As indicated above, the measurement module 512 of the timing device 504 may be configured to execute the timing sequence of a flammability test automatically, such as by implementing programming logic or computer-readable instructions stored on a memory element. Thus, the test selection switch 518 may permit an operator to indicate to the timing device 504 the particular test being conducted such that the device 504 will execute the proper timing sequence. For example, as shown in FIG. 6, the test selection switch 518 allows an operator to choose between the UL94 and the FMVSS302 timing sequences.

The timing device 504 may also include one or more display devices for visually displaying data, such as time interval measurements. For example, as shown in FIG. 6, the control panel 514 of the timing device may include one or more display panels 520a,520b,520c or other suitable visual devices for displaying time interval measurements relating to the timing signals received for a given timing sequence. For example, display panel 520a may visually display the time measurement for time interval #1 of the UL94 test, indicating the amount of time the test specimen 22 afterflamed subsequent to the first ten second exposure period. Similarly, display panels 520a,520b may display the time measurements for time interval #2 and time interval #3, respectively, of the UL94 test. Alternatively, if FMVSS302 testing is being conducted, one of the display panels 520a,520b,520c may display the FMV time interval, indicating the amount of time it took for the first of the three burn conditions to occur.

Further, the timing device 504 may also include one or more audio output devices 522 for providing an audible alarm to the operator. For example, as shown in FIG. 6, the audio output device 522 may comprise a speaker mounted in the control panel 514. Thus, in one embodiment, the timing device 504 may be configured to produce an audible alarm, such as by sending an appropriate signal to the speaker, to indicate that a flame exposure period has ended. In other words, an audible alarm may be produced to alert the operator that one of the ten second flame exposure periods of the UL94 test or the fifteen second flame exposure period of the FMVSS302 test has run and, thus, the test specimen 22 should be removed from the flame.

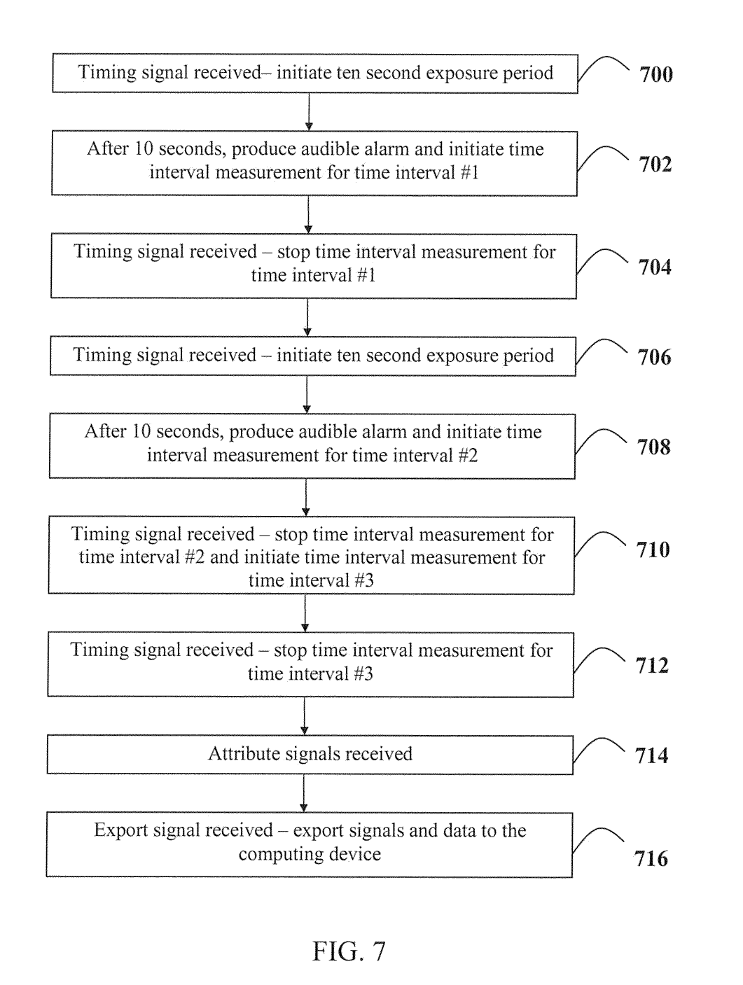

As generally described above, the timing device 504 may be configured to implement the timing sequence of a specified flammability test in order to perform any required time interval measurements. Thus, as an example, FIG. 7 illustrates an embodiment of the steps that may be executed by the timing device 504 in implementing the timing sequence for UL94 testing. Of course, it should be appreciated that a similar series of steps may be implemented for executing the timing sequence of the FMVSS302 test.

Referring to FIG. 7, an operator may commence the UL94 flammability test by initially exposing the test specimen 22 to the flame of the burner element 24 for a ten second period. Additionally, in accordance with aspects of the present subject matter, the operator may input a timing signal, such as by pressing/pushing the timer button 510 or similar input device, simultaneously with exposure of the test specimen to the flame. This timing signal may then be received by the timing device 504, as shown in step 700, which indicates that the ten second exposure period should be initiated. For example, the timing device 504 may be configured to count ten seconds, such as by controlling an internal timer implemented with programming logic and/or computer readable, instructions programmed into or stored within the timing device 504.

In step 702, the timing device 504 produces an audible alarm, such as with the audio output device 522, to indicate to the operator that the ten second period has run and that the test specimen 22 should be removed from the flame. Additionally, step 702 requires that the timing device 504 initiate the time interval measurement for time interval #1. Thus, the timing device 504 may begin to perform the time measurement for time interval #1 automatically as soon as the alarm sounds. The operator may then observe the test specimen 22 and, when the after flame extinguishes, input a timing signal by pushing/pressing the timer button 510. In step 704, the timing signal is received by the timing device 504, indicating that the time interval measurement for time interval #1 should be stopped. At this point, the timing device 504 has measured time interval #1 and may, in one embodiment, display the time interval on one of the display panels 520a,520b,520c of the control panel 514.

Referring still to FIG. 7, the operator may then re-expose the test specimen 22 to the flame and again press the timer button 510. This press of the timer button 510 indicates to the timing device 504 that the ten second exposure period should be initiated, as shown in step 706. In step 708, the timing device 504 produces another audible alarm to indicate that the ten second exposure period has run and that the test specimen 22 should be removed from the flame. Additionally, step 708 requires the timing device to initiate the time interval measurement for time interval #2. Thus, the timing device 504 may begin to perform a time measurement for time interval #2 as soon as the alarm sounds and the operator removes the specimen 22 from the flame. The operator may then observe the test specimen 22 and, when the afterflame extinguishes, push/press the timer button 510. In step 710, the timing signal is received from the timer button 510, indicating that the time interval measurement for time interval #2 should be stopped. At this point, the timing device 504 has measured time interval #2 and may, in one embodiment, display the time interval on one of the display panels 520a,520b,520c of the control panel 514.

Moreover, the timing signal received in step 710 also indicates that the afterglow time interval measurement for time interval #3 should be initiated by the timing device 504. The operator may then observe the specimen 22 until the afterglow ceases and press the timer button 510 to indicate such. In step 712, this timing signal is received by the timing device 504, indicating that the afterglow time interval measurement for time interval #3 is complete. At this point, the timing device 504 has measured time interval #3 and may, in one embodiment, display the time interval on one of the display panels 520a,520b,520c of the control panel 514. Finally, the operator may observe the selected attributes required for UL94 testing and record any observations by manipulating the attribute switches 516a,516b,516c disposed on the control panel 514. Thus, in step 714, the attribute signals from the switches 516a,516b,516c may be received by the timing device 504 to be stored or prepared for export to the computing device 506.

As indicated above, the timing device 504 may be coupled to the computing device 506. Thus, the timing device 504 may be configured to export an electronic file or electronic signals that may be received and understood by the computing device 506. For instance, the timing device 504 may be configured to convert the one or more time interval measurements into one or more time interval signals that can be read by the computing device 506 and understood as concrete time measurements. Additionally, the timing device 504 may be configured to export any attribute signals received as inputs to the computing device 506. It should be appreciated that, in one embodiment, the timing device 504 may continuously export the electronic data and/or signals to the computing device as such data and/or signals are received or created by the timing device 504. Alternatively, the timing device 504 may be configured to export any and all signals and/or other data after a particular flammability test has been completed. For example, referring to FIG. 6, the control panel 514 of the timing device 504 may include a further input device, such as an export button 524, for electronically providing an export signal to the timing device 504. The export signal may, for example, indicate to the timing device 504 that a particular flammability test has been completed. Thus, when an export signal is received, the timing device 504 may then export any signals and/or data to the computing device 506, as shown in step 716 of FIG. 7.

The computing device 506 of the present subject matter may generally be configured to analyze any signals and/or other data received from the timing device 504. Particularly, in one embodiment, the computing, device 506 may be configured to analyze the time interval measurements performed by the timing device 504, as well as any attribute signals imported from the timing device 504, to determine the flammability classification of a particular test material in accordance with the specified flammability test being conducted. Tints, it should be appreciated that the computing device 506 may be equipped with any standard Laboratory Information Management System (LIMS) and/or any other suitable software capable of reading and analyzing the imported signals and/or data.

As shown in FIG. 5, the computing device 506 may generally include one or more memory elements 526 or any other suitable database for storing signals and/or data exported from the timing device 504. It should be appreciated that memory elements 526 may be provided as single or multiple portions of one or more varieties of computer-readable media, such as but not limited to any combination of volatile memory (e.g., random access memory (RAM, such as DRAM, SRAM, etc.) and nonvolatile memory (e.g., ROM, flash, hard drives, magnetic tapes, CD-ROM, DVD-ROM, etc.) or any other memory devices including diskettes, drives, other magnetic-based storage media, optical storage media and others.

The memory elements 526 may also store software and/or firmware in the form of computer-readable and executable instructions that may be implemented by one or more of the processors 528 of the computing device 506. Thus, the processors 528 and associated memory elements 526 may be configured to perform a variety of computer-implemented functions. In one embodiment, the processors 528 may be configured to analyze the time interval measurements and attribute signals to determine the flammability classification for a test specimen 22. As such, it should be appreciated that the computer readable instructions may relate to the classification criteria of a specified flammability test. Accordingly, the instructions may configure the processors 528 of the computing device 506 to compare the time interval measurements and attribute signals received from the timing device 504 to the classification criteria of the flammability test being conducted. In such an embodiment, it should be readily appreciated that the classification criteria may be stored in the memory elements 526 as input parameters provided from the operator or may be preprogrammed into the computing device 506.

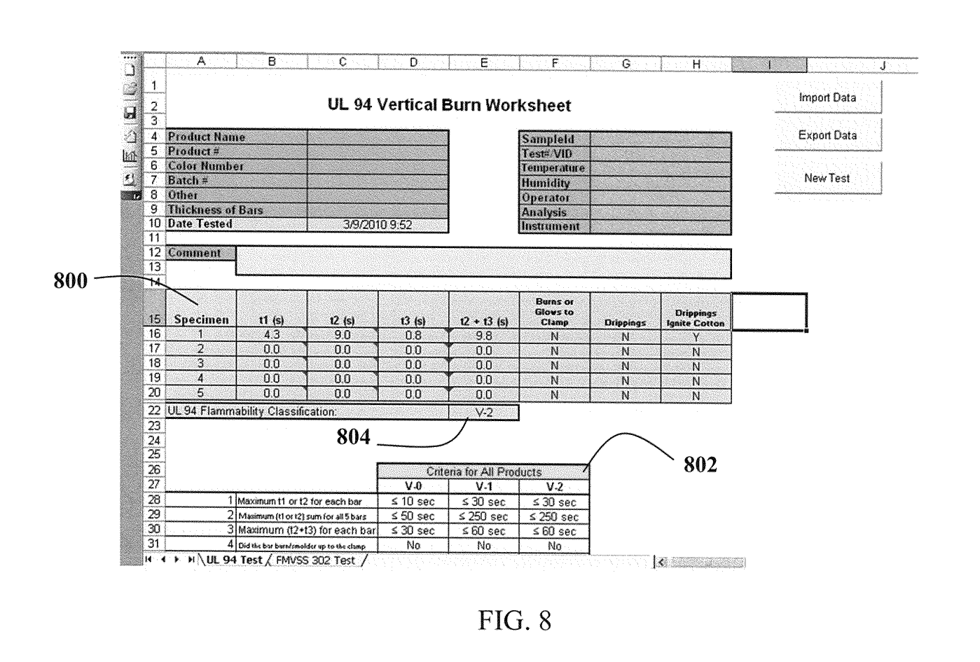

It should also be appreciated that the processors 528 may also be configured to organize any signals and/or data received from the timing device 504 as well as the determined flammability classification for a particular test material. Thus, it should be appreciated that software instructions may be stored in the memory elements 526 of the computing device 506 which configure the processor(s) 528 to organize such signals/data/classifications into a format that may be displayed on an output device 508, such as a computer monitor or other visual display. For example, FIG. 8 illustrates a screenshot demonstrating how the information received and analyzed by the computing device 506 may be organized and displayed on an output device 508 to permit such information to be easily understood by the operator or any other user. As shown, a results table 800 may be included that displays the time interval measurements taken for each test specimen as well as any recorded attributes. Additionally, a classification table 802 may be displayed indicating the particular criteria used by the computing device 506 to determine the classification of the test material. Further, the determined flammability classification for the particular material being tested may be displayed in a classification block 804 to indicate the final results of the testing.

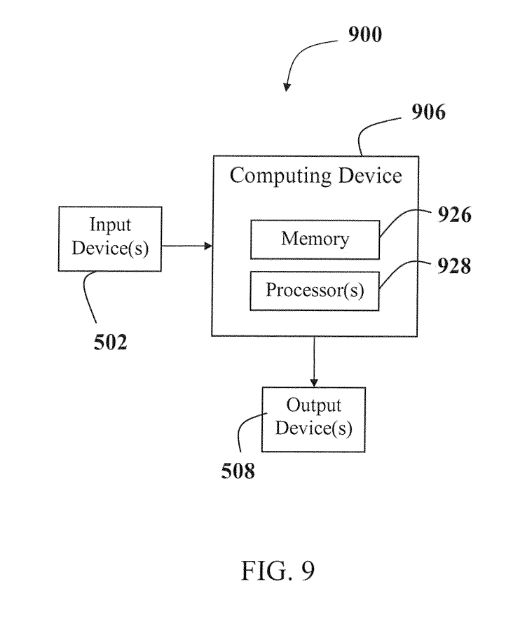

Referring now to FIG. 9, a further embodiment of a system 900 is illustrated for collecting and analyzing the measurements and observations required during flammability testing in order to determine the flammability classification of a test material. Generally, the system 900 may include one or more input devices 502 for electronically providing input signals. Additionally, a computing device 906 may be coupled to the input devices 502 and may be configured to both perform one or more time interval measurements and analyze these measurements along with any other signals received from the input devices 502 to determine the flammability classification of a test material in accordance with a specified flammability test. Further, the system may include one or more output devices 508, such as a monitor, printer or other device for visually depicting any available output data, such as time measurements, flammability classifications, and the like.

It should be appreciated that the input devices 502 and the output devices 508 may be generally configured as described and illustrated herein. Further, in this embodiment, it should be appreciated that the computing device 906 may be generally configured to perform the functions executed by both the timing device 504 and the computing device 506, as generally described above with reference to FIGS. 5-8. Thus, the computing device 906 may be capable of automating the timing sequence of a particular flammability test in order to perform any necessary time interval measurements, such as time intervals #1-3. As such, the computing device 906 may comprise one or more memory elements 926 for storing computer-readable instructions capable of being executed by one or more processors 928. For example, the computer-readable instructions may configure the processors 928 to implement the timing sequence of a specified flammability test to enable the computing device 906 to perform time interval measurements. Moreover, as indicated above, the processors 928 may be configured to analyze the time interval measurements and any attribute signals received by the computing device 906 to determine the flammability classification of a test material. Thus, it should be appreciated that any computer-readable instructions stored in the memory element(s) 926 may also relate to the classification criteria of a specified flammability test.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for collecting and analyzing the measurements and observations required during flammability testing in order to determine the flammability classification of a test material, the system comprising:
one or more input devices for electronically providing one or more timing signals related to a timing sequence of a specified flammability test and one or more attribute signals related to selected attributes of a test specimen;
a timing device coupled to said one or more input devices, said timing device configured to perform one or more time interval measurements based on the one or more timing signals; and
a computing device coupled to said timing device, said computing device configured to analyze the one or more time interval measurements and the one or more attribute signals to determine a flammability classification for said test specimen in accordance with said specified flammability test.

2. The system of claim 1, further comprising a testing unit including a burner element and a specimen holder, said burner element configured to produce a controlled flame, said specimen holder configured to hold said test specimen adjacent to said burner element to permit exposure of said test specimen to said controlled flame

3. The system of claim 1, wherein said one or more input devices comprise a timer button and one or more attribute switches.

4. The system of claim 1, wherein said one or more input devices are further configured to electronically provide a test selection signal that configures said timing device to perform said one or more time interval measurements based on a timing sequence of a first specified flammability test or a second specified flammability test.

5. The system of claim 1, wherein said selected attributes of said test specimen comprise whether said test specimen burned up to a specified location and whether said test specimen dripped and ignited a cotton indicator.

6. The system of claim 1, wherein said selected attributes of said test specimen comprise an unburned length of said test specimen.

7. The system of claim 1, further comprising an audio output device for producing an audible alarm, said audible alarm being produced to indicate that a flame exposure period of said timing sequence has run.

8. The system of claim 1, wherein said timing device comprises a hard-wired circuit that configures said timing device to perform said one or more time interval measurements.

9. The system of claim 1, wherein said timing device comprises a computer-readable medium storing instructions that configure said timing device to perform said one or more time interval measurements.

10. The system of claim 1, wherein said test specimen comprises a polymeric material.

11. A system for collecting and analyzing the measurements and observations required during flammability testing in order to determine the flammability classification of a test material, the system comprising:
one or more input devices for electronically providing one or more timing signals related to a timing sequence of a specified flammability test and one or more attribute signals related to selected attributes of a test specimen; and
a computing device coupled to said one or more input devices, said computing device configured to perform one or more time interval measurements based on the one or more timing signals and analyze the one or more time interval measurements and the one or more attribute signals to determine a flammability classification for said test specimen in accordance with said specified flammability test.

12. The system of claim 11, further comprising a testing unit including a burner element and a specimen holder, said burner element configured to produce a controlled flame, said specimen holder configured to hold said test specimen adjacent to said burner element to permit exposure of said test specimen to said controlled flame

13. The system of claim 11, wherein said one or more input devices comprises a timer button.

14. The system of claim 1 wherein said one or more input devices comprises a mouse or a keyboard.

15. The system of claim 11, wherein said one or more input devices are further configured to electronically provide a test selection signal that configures said computing device to perform said one or more time interval measurements based on a timing sequence of a first specified flammability test or a second specified flammability test.

16. The system of claim 11, wherein said selected attributes of said test specimen comprise whether said test specimen burned up to a specified location and whether said test specimen dripped and ignited a cotton indicator.

17. The system of claim 11, wherein said selected attributes of said test specimen comprise an unburned length of said test specimen.

18. The system of claim 11, further comprising audio output device for producing an audible alarm, said audible alarm being produced to indicate that a flame exposure period of said timing sequence has run.

19. The system of claim 11, wherein said computing device comprises a computer-readable medium storing instructions that configure said computing device to perform said one or more time interval measurements and analyze the one or more time interval measurements and the one or more attribute signals to determine a flammability classification for said test specimen in accordance with said specified flammability test.

20. The system of claim 11, wherein said test specimen comprises a polymeric material.

21. A method for collecting and analyzing the measurements and observations required during flammability testing in order to determine the flammability classification of a test material, the method comprising:
electronically receiving a plurality of timing signals related to a timing sequence of a specified flammability test;
electronically receiving one or more attribute signals related to selected attributes of a test specimen;
automatically performing on or more time interval measurements based on said plurality of timing signals; and
analyzing said on or more time interval measurements and said one or more attribute signals to determine a flammability classification for said test specimen in accordance with said specified flammability test.

22. The method of claim 21, wherein said one or more time interval measurements are performed by a timing device or a computing device.

23. The method of claim 21, wherein said test specimen comprises a polymeric material.

24. A system for collecting and analyzing time measurements, the system comprising:
one or more input devices for electronically providing one or more timing signals related to a timing sequence of a specified testing procedure;
a timing device coupled to said one or more input devices, said timing device configured to perform one or more time interval measurements based on the one or more timing signals; and
a computing device coupled to said timing device, said computing device configured to analyze the one or more time interval measurements.
